(19) United States
(12) Patent Application Publication
(10) Pub. No.: US 2015/0145185 A1
(43) Pub. Date: May 28, 2015

(54) Torch guide for metal cutting

(71) Applicant: Leslie Cole, Turtle Creek (CA)

(72) Inventor: Leslie Cole, Turtle Creek (CA)

(21) Appl. No.: 14/544,016

(22) Filed: Nov. 14, 2014

(30) Foreign Application Priority Data
Nov. 27, 2013 (CA) 2834530

(51) Int. Cl. B23K 7/10

(52) U.S. Cl. CPC B23K 7/10
USPC 266/48

(57) ABSTRACT

The torch guide encloses a structural metal section to be cut on four sides of that metal section. The cutting torch guide has co-planar top and bottom guiding surfaces and parallel first and second side guiding surfaces. The top and bottom guiding surfaces intersect the first and second side guiding surfaces at four points lying in a same plane. All four guiding surfaces being aligned perpendicular to a longitudinal axis of the structural metal section to be cut, for guiding a cutting torch around the entire structural metal section to be cut. The top and bottom guiding surfaces are adjustable at angle of 90° to 45° from the longitudinal axis, while maintaining the alignment of all four guiding surfaces along a planar cutting plane through the structural metal section to be cut.

### FIELD OF THE INVENTION

This invention pertains to adjustable jigs for guiding a cutting torch around a structural metal section, and more particularly, it pertains to a torch guide for enclosing a structural metal section and for guiding a cutting torch along a cut line around the structural metal section.

### BACKGROUND OF THE INVENTION

Metal fabrication shops use acetylene cutting torches or plasma-arc cutting torches for cutting structural channels, angles and rectangular hollow structural metal sections to different length and angles. Other more modern cutting tools, such as water-cutting jet and laser cutting torches are also used.

When a fabrication shop uses one of the traditional cutting torches such as acetylene or a plasma-arc type, a guiding edge is needed to guide the cutting torch with precision along an intended cutting line. The torch-guiding tools described in the prior art are somewhat limited to rulers and guide blocks. These rulers are clamped to the workpiece to be cut. Examples of rulers and torch guide blocks are illustrated and described in the following documents:

U.S. Pat. No. 4,391,433 issued to Robert L. Doan on Jul, 5, 1983;
U.S. Pat. No. 4,767,102 issued to Mario Dube, on Aug, 30, 1988;
U.S. Pat. No. 6,620,373 issued to Gene C. DeCamp on Sep, 16, 2003.

Although the guide rulers of the prior art deserve undeniable merits, these rulers are more appropriate for use along a same plane, such as for cutting steel plates and similar large planar objects. These rulers are difficult to use during the cutting of a structural member such as a steel channel for example. The ruler needs to be repositioned and clamped to the workpiece before every cut around the workpiece. The ruler needs to be set up four times to cut a hollow rectangular structural steel section for example. The prior art in the field of metal fabrication does not suggest any instrument for cutting a workpiece such as a hollow structural steel section in one setup.

It is believed that a need exists in the metal fabrication industry for a torch guide that can be used for cutting rectangular hollow structural metal sections, structural channels and structural angles of different sizes at different angles, in one setup.

### SUMMARY OF THE INVENTION

In the present invention, there is provided a torch guide that has a top and bottom guiding surfaces and first and second side guiding surfaces. All four guiding surfaces are adjustably affixed to each other for defining a square or a rectangle enclosing a structural metal section to be cut. The torch guide according to the present invention is set to define an intended cutting plane through the structural section to be cut. A cutting torch can then be moved along the torch guide to perform a precise cut along the intended cutting plane.

In one aspect of the present invention, there is provided a cutting torch guide that has parallel and spaced-apart top and bottom guiding surfaces and parallel and spaced-apart first and second side guiding surfaces. The top and bottom guiding surfaces intersect the first and second side guiding surfaces at four points defining a planar square or rectangle. All four guiding surfaces are aligned perpendicular to a longitudinal axis of the metal section to be cut, for guiding a cutting torch in a proper cutting orientation around the entire section to be cut.

In another aspect of the present invention, the top and bottom guiding surfaces are adjustable at angles of between 90° and 45° from the first and second side guiding surfaces. Each of the top, bottom and side guiding surfaces have an inside edge that is contiguous with the aforesaid planar square or rectangle.

The torch guide according to the present invention can be used to work on hollow structural metal section, on structural channels and on structural angles.

This brief summary has been provided so that the nature of the invention may be understood quickly. A more complete understanding of the invention can be obtained by reference to the following detailed description of the preferred embodiment thereof in connection with the attached drawings.

### BRIEF DESCRIPTION OF THE DRAWINGS

A preferred embodiment of the present invention is illustrated in the accompanying drawings, in which like numerals denote like parts throughout the several views, and in which:

FIG. 1 is a perspective view the torch guide according to the preferred embodiment of the present invention in use on a hollow structural steel section;

FIG. 2 is an exploded view of the preferred torch guide;

FIG. 3 is an end view of the preferred torch guide mounted on a hollow structural steel section having a longer cross-section dimension set horizontally;

FIG. 4 is an end view of the preferred torch guide mounted on a hollow structural steel section having a longer cross-section dimension set vertically;

FIG. 5 is a top view of the preferred torch guide mounted on a hollow structural steel section;

FIG. 6 is an end view of the preferred torch guide mounted on a structural channel section;

FIG. 7 is an end view of the preferred torch guide mounted on a structural angle section;

FIG. 8 is a perspective top and end view of the preferred torch guide set at a forty-five degree angle on a hollow structural section;

FIG. 9 is a top view of the preferred torch guide set at a forty-five degree angle on a hollow structural section;

FIG. 10 is a perspective view of the basic structure of the preferred torch guide.

### DESCRIPTION OF THE PREFERRED EMBODIMENT

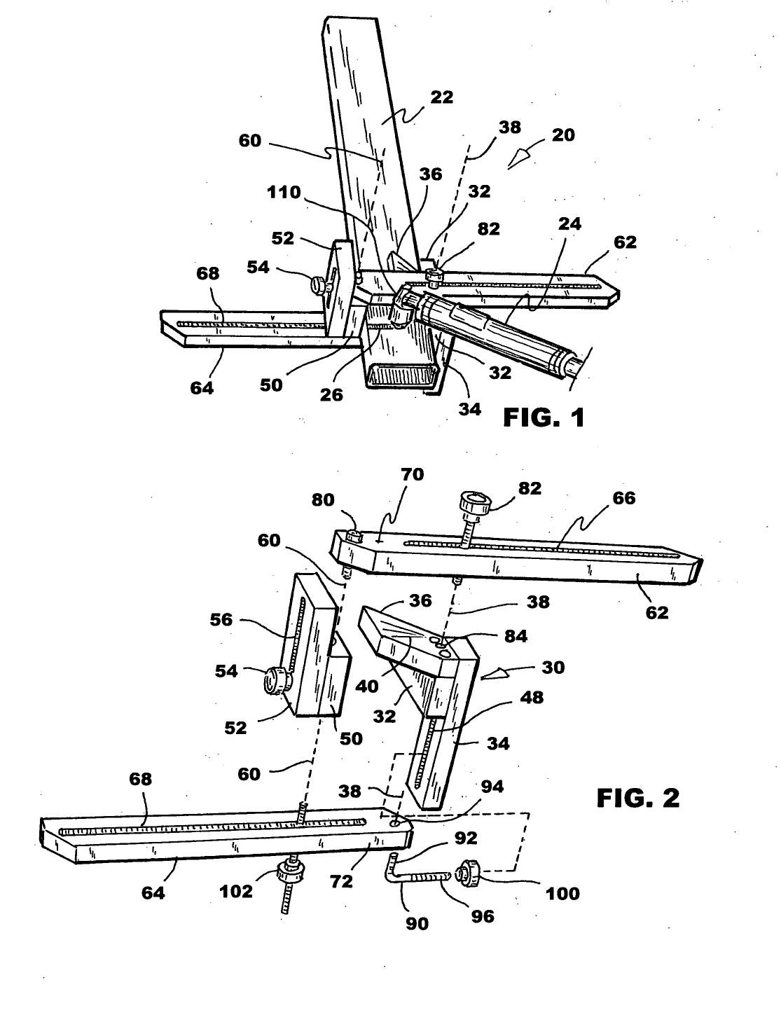

Referring to FIG. 1, the preferred torch guide 20 is mounted on a piece of rectangular hollow structural metal section 22. A cutting torch 24 is guided against the preferred torch guide 20, along a cut line 26 being made through the top wall of the rectangular hollow structural metal section 22.

For convenience, the preferred torch guide 20 will be described herein using spacial expressions that correspond to the structural section to be cut therewith. For example, the width, depth, length, top, bottom, left and right sides of the preferred torch guide 20 correspond to the width, depth, length, top and bottom'surfaces and left and right side surfaces of the rectangular hollow structural metal section 22 as illustrated in FIG. 1. Also, the word rectangle is used herein to designate either a rectangle or a square. The words rectangle and square are also used herein interchangeably with the expression “a closed four-sided plane figure”.

As can be seen in FIGS. 1 and 2, the preferred torch guide 20 is made of the following elements. A base member 30 rests against the right-hand side surface of the rectangular hollow structural metal section 22 to be cut. This base member 30 is comprises of a rectangular base pad 32 with its longer dimension extending along the side surface of the rectangular hollow structural metal section 22 to be cut. A leg member 34 is permanently affixed to the base pad 32 and extends in a same plane as the base pad 32, but at a right angle from the longer dimension of the base pad 32. The leg member 34 has a slot therein for receiving a bolt in an adjustable manner.

The base member 30 also has a protractor member 36 permanently affixed to a top surface of the base pad 32. The protractor member 36 extends over the top surface of the piece to be cut, at a right angle from the side surface of the pad member 32.

A first axis of articulation of the preferred torch guide 20 extends along the dashed line 38 as shown in FIGS. 1 and 2. The protractor member 36 has graduations 40 printed or engraved thereon. These graduations are made in reference with the first axis of articulation 38 of the preferred torch guide 20. Although the axis of articulation 38 is mentioned at this early stage of the specification, the preferred torch guide 20 does not need to be articulated about the axis 38 when it is used to cut a steel section at a right angle as illustrated in FIGS. 1 to 7.

As can be appreciated, the side of the leg member 34 facing the reader constitutes a torch guiding surface along the right side surface of the metal section to be cut. The other side surfaces facing the reader in FIG. 2 on the other elements of the preferred torch guide 20 constitute other torch guiding surfaces along the top, bottom and left side surfaces of the workpiece to be cut.

A follower block 50 is positioned opposite from the base pad 32, on the left-hand side of the preferred torch guide 20. An overlap pad 52 is mounted against the follower block 50 by means of a bolt 54. The overlap pad 52 has a vertical slot 56 therein, in which the bolt 54 is mounted. The side surfaces on both the follower block 50 and the overlap pad 52 jointly constitute a guiding surface along the left side surface of the workpiece to be cut. Because of the bolt 54 and slot 56, the overlap pad 52 can be adjusted in depth relative to the follower block 50, for guiding a torch along the side surface of a work piece that is deeper or thicker than the one shown in FIG. 1.

The follower block 50 has a second axis of articulation 60 of the preferred torch guide 20 passing there through. Again, adjustment of the preferred torch guide 20 about the second axis of articulation 60 is needed only to adjust the preferred torch guide 20 for cutting at an angle other than a right angle. A threaded hole (not shown) passes through the follower block 50 along the second axis of articulation 60.

A top and bottom guide bars 62, 64 have a respective longitudinal slot, 66, 68 there along and are angularly adjustable relative to the first and second axes of articulation 38, 60. For reference purposes, each of the guide bars 62, 64 has a captive end 70, 72 respectively mounted to one of the follower block 50 and the leg member 34, and a free end extending away from the follower block 50 and the leg member 34. The top guide bar 62 has a cap screw 80 through its captive end 70. This cap screw 80 is mounted to a threaded hole in the top surface of the follower block 50. The cap screw 80 and the threaded hole in the follower block 50 extend along the second axis of articulation 60. The top guide bar 62 is retained to the base member 30 by means of a thumb screw 82 passing through the slot 66 and extending into a threaded hole 84 extending into the protractor 36 along the first axis of articulation 38. Because of the thumb screw 82 and the cap screw 80 the follower block 50 is movable toward and away from the base member 30 to adjust to different widths of structural sections to be cut.

The bottom guide bar 64 has its captive end 72 adjustably held to the leg member 34 of the preferred torch guide 20. The captive end 72 of the bottom guide bar 64 is held to a L-shaped bolt 90. The L-shaped bolt 90 has a vertical threaded portion 92 extending into a threaded hole 94 through the captive end 72 of the bottom guide bar 64. The L-shaped bolt 90 has a horizontal threaded portion 96 extending through a slot 48 along the leg member 34. A thumb nut 100 mounts to the horizontal threaded portion 96 to retain the captive end 72 of the bottom guide bar 64 to the leg member 34. The captive end 72 of the bottom guide bar 64 is configured so that when the thumb nut 100 is tightened against the leg member 34, the vertical portion 92 of the L-shaped bolt 90 can be brought to align with the first axis of articulation 38. Another thumb screw 102 extends through the slot 68 of the bottom guide bar 64 to retain an intermediate segment of this guide bar 64 to the follower block 50. The thumb screw 102 extends along the second axis of articulation 60, and is threaded into a hole (not shown) through the bottom of the follower block 50 along the axis 60.

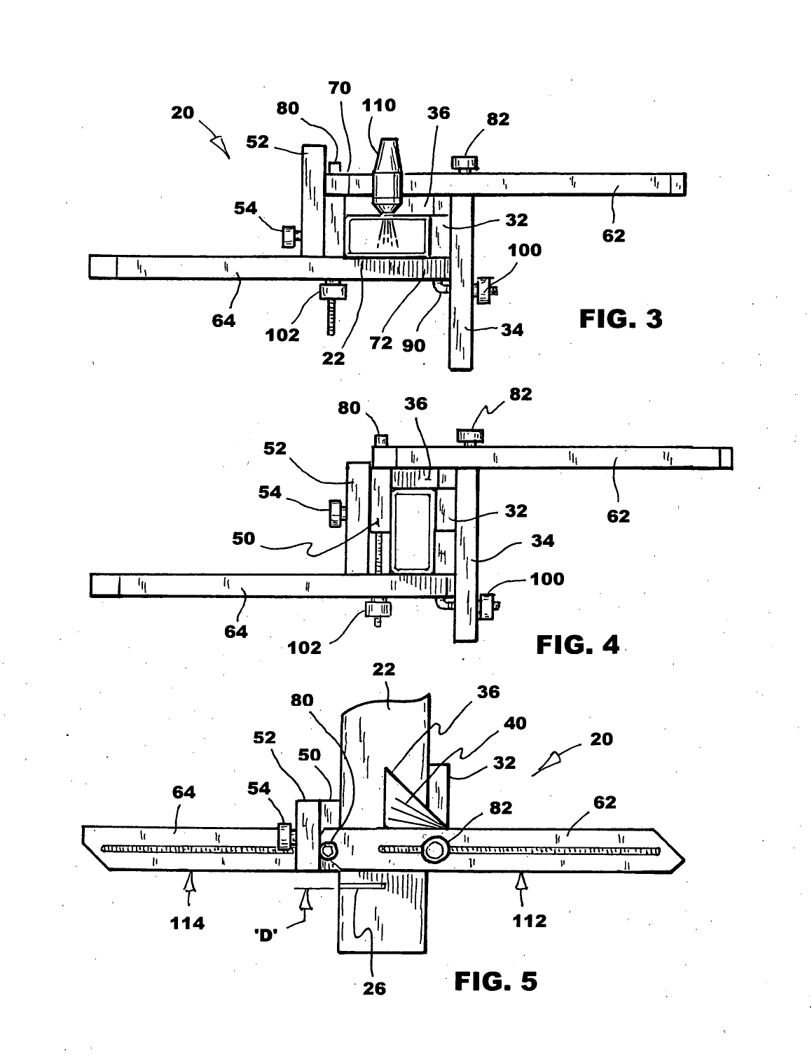

Referring now to FIGS. 3, 4 and 5, it will be appreciated that the preferred torch guide 20 is adjustable in width by means of the thumb screws 82 and 102 to accommodate structural sections of different widths. The preferred torch guide 20 is also adjustable in depth as can be seen in

FIG. 4, by means of thumb nut 100 and thumb screw 102. When an adjustment in depth is effected, it is preferable to adjust the overlap pad 52 accordingly, by means of thumb screw 54, as shown in FIG. 4, to obtain a continuous guiding surface along the left side surface of the section to be cut.

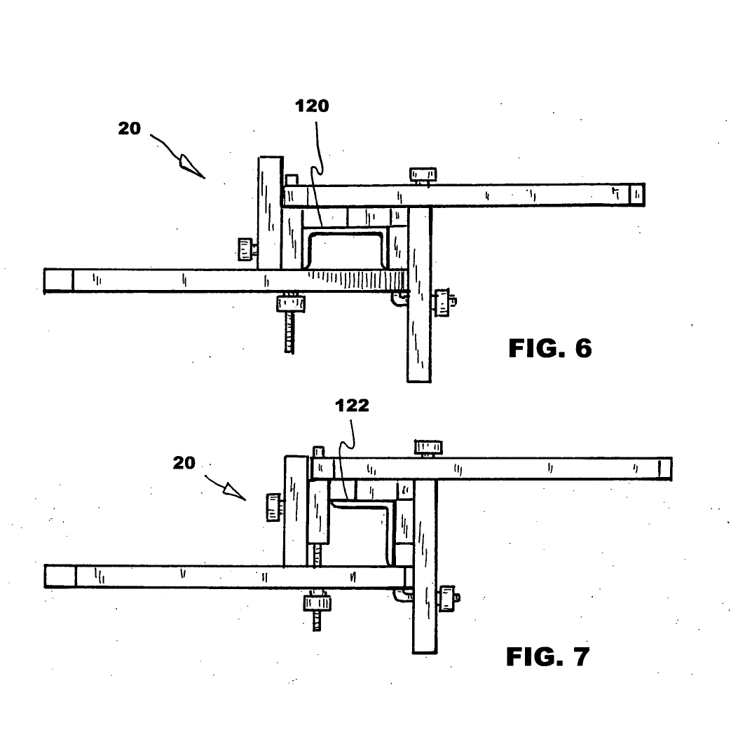

Referring particularly to FIG. 5, it will be appreciated that the preferred torch guide 20 is positioned at a distance “D” from the intended cut line 26. It will also be appreciated that the distance “D” corresponds to the radius of the tip 110 of the cutting torch 24. The side edges 112, 114 of the guide bars 62, 64 respectively, the side edges of the base pad 32; the leg member 34; the follower block 50 and the overlap block 52 constitute guiding surfaces for guiding the tip 110 of a cutting torch along a cut line 26 around the workpiece to be cut. As can also be appreciated, the preferred torch guide 20 can be used to cut different structural sections, such as a channel 120 as shown in FIG. 6 and a structural angle section 122 as shown in FIG. 7.

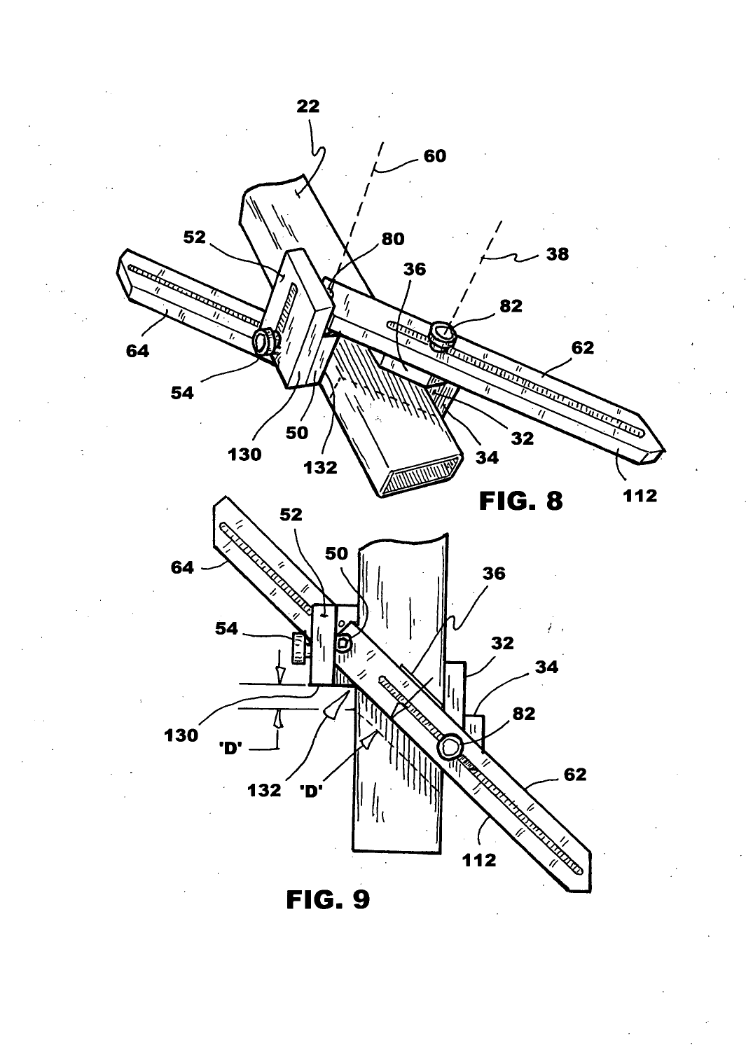

Referring to FIGS. 8 and 9, the preferred torch guide 20 is adjustable for guiding a cutting torch along an angle of between ninety degrees and forty-five degrees (90° and 45°). Because of the axes of articulation 38, 60 through thumb screws 82 and cap screw 80 respectively, the preferred torch guide 20 can be adjusted to any angles indicated on the protractor 36.

Because of the location of the articulation axes 38, 60 relative to the widths of the guide members 62, 64, the vertical guiding surface 130 of the follower block 50 intersects the horizontal guiding surface 112 of the top guide member 62 at line 132. This line 132 lies on the side surface of the metal section 22 to be cut. A second line of intersection (not shown) is formed between the guiding surfaces of the base members 32 and the horizontal guiding surface 112. As can be understood, both vertical lines of intersection described above also intersect the guiding surface of the bottom guide member 64. Therefore, the distance “D” along both the horizontal surfaces of the workpiece to be cut is a same distance “D” along both vertical surfaces of the workpiece, as it may be understood from FIG. 9.

More particularly, the depth of the horizontal guide members 62, 64, is a same dimension as a thickness of the base pad 32 and a same dimension as the thickness of the follower block 50, which is one half of the width of the horizontal the guide members 62, 64. The axis of articulations 38 and 60 passes through a width-wise median of the horizontal guide members 62, 64, and through a thickness-wise median of the base pad 32 and of the follower block 50.

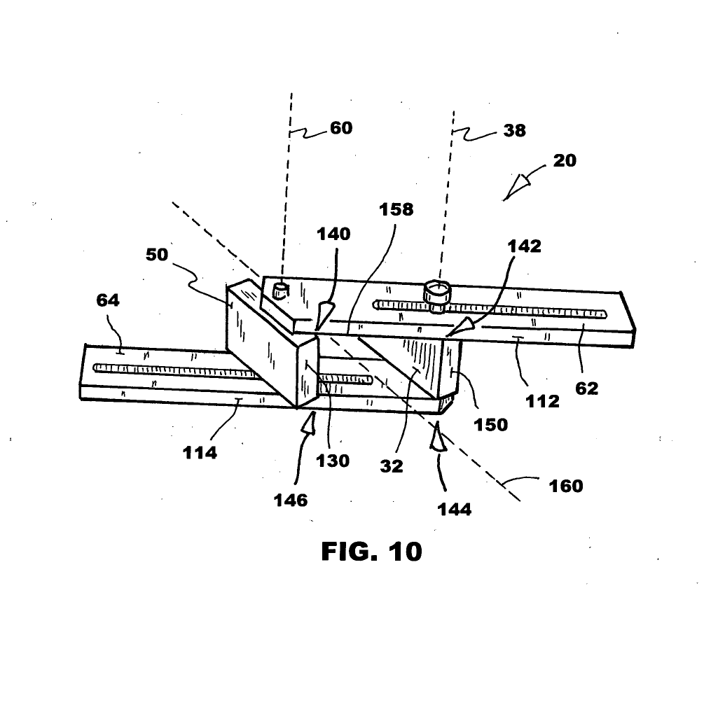

For a better understanding, the basic structure of the preferred torch guide 20 is illustrated in FIG. 10. The two guide bars 62, 64, with the base pad 32 and the follower block 50 form a rectangle around a workpiece to be cut. This rectangle is defined by four corners 140, 142, 144, 146. The guiding surfaces 130, 150 of the follower block 50 and of the base pad 32 respectively, intersect the guiding surface 112 of the top guide bar 62 at points 140 and 142 respectively. The guiding surfaces 130, 150 of the follower block 50 and the base pad 32 respectively, intersect the guiding surface 114 of the bottom guide bar 64 at points 146 and 144 respectively.

In use, the guiding surfaces 130, 150 of the follower block 50 and the base pad 32 respectively, are set parallel to each other. The guiding surfaces 112, 114 of guide bars 62 and 64 respectively, are set in a co-planar relationship with each other. The intersection points 140, 142, 144, 146 jointly define a closed four-sided plane figure; a cutting plane 158, whether the guiding surfaces 130, and 150 are set parallel with the guiding surfaces 112 and 114, or set at an angle of 45° with the guiding surfaces 112 and 114.

In FIG. 10, the dashed line 160 represents the longitudinal axis of the preferred torch guide 20, and of the longitudinal axis of the structural metal section to be cut. All four guiding surfaces 130, 150, 112, 114 are aligned perpendicular to this longitudinal axis 160.

As to further construction details, and other method of use of the preferred torch guide, these details should be apparent to those skilled in the art, and accordingly, further description relative to these aspects is deemed unnecessary.

What is claimed is:

1. A torch guide having a longitudinal axis, comprising;
a top and bottom guiding surfaces and first and second side guiding surfaces; said top and bottom guiding surfaces intersecting said first and second side guiding surfaces at four points lying in a same plane; said four points defining a closed four-sided cutting plane for enclosing a structural metal section to be cut;
said first side guiding surface having a first articulation affixed thereto; said first articulation extending along a first axis of articulation; said first articulation connecting said first side guiding surface to said top and bottom guiding surfaces for adjusting a planar alignment of said first side guiding surface relative to said top and bottom guiding surfaces;
said second side guiding surface having a second articulation affixed thereto; said second articulation extending along a second axis of articulation; said second articulation connecting said second side guiding surface to said top and bottom guiding surfaces for adjusting a planar alignment of said second side guiding surface relative to said top and bottom guiding surfaces and relative to said first side guiding surface, and
said first and second axes of articulation extending parallel with said closed four-sided cutting plane.

2. The torch guide as claimed in claim 1, wherein said top and bottom guiding surfaces extending in a same plane and said first and second side guiding surfaces extending in respective distinct and parallel planes different from said same plane.

3. The torch guide as claimed in claim 2, wherein said top and bottom guiding surfaces each having a dimension extending at a right angle from said longitudinal axis.

4. The torch guide as claimed in claim 1, having adjustment slots therein, and said first and second side guiding surfaces being movable toward and away from each other along said adjustment slots, and said top and bottom guiding surfaces being movable toward and away from each other along said adjustment slots.

5. The torch guide as claimed in claim 1, wherein each of said top and bottom guiding surfaces and said first and second side guiding surfaces having an inside linear edge relative to a center of said closed four-sided cutting plane, and each of said inside linear edges being contiguous with one side of said closed four-sided cutting plane.

6. The torch guide as claimed in claim 4, wherein each one of said first and second articulation axes passing through one of said adjustment slots.

7. The torch guide as claimed in claim 1, further having thumb nut and screws incorporated therein and said top and bottom guiding surfaces and said first and second side guiding surfaces being adjustable relative to each other by working said thumb nut and screws.

8. The torch guide as claimed in claim 6, wherein said top and bottom guiding surfaces are set at an angle of 45° from said first and second side guiding surfaces.

9. The torch guide as claimed in claim 8, wherein said closed four-sided cutting plane is co-planar with said top and bottom guiding surfaces.

10. A torch guide having a longitudinal axis, comprising
a top and bottom guide members and first and second side guide members;
said first side guide member having a first articulation affixed thereto; said first articulation extending along a first axis of articulation; said first articulation connecting said first side guide member to said top and bottom guide members for adjusting a planar alignment of said first side guide member relative to said top and bottom guide members;
said second side guide member having a second articulation affixed thereto; said second articulation extending along a second axis of articulation; said second articulation connecting said second side guide member to said top and bottom guide members for adjusting a planar alignment of said second side guide member relative to said top and bottom guide members and relative to said first side guide member, and
said top guide member being movably affixed to said first and second side guide members about said first and second axes of articulation;
said bottom guide member being movably affixed to said first and second side guide members about said first and second axes of articulation;
said bottom guide member being held at a spaced-apart parallel relationship with said top guide member;
said top and bottom guide members and said first and second side guide members defining a closed four-sided cutting plane for enclosing a structural metal section to be cut, and
said first and second axes of articulation extending parallel with said closed four-sided cutting plane.

11. The torch guide as claimed in claim 10, wherein each of said top and bottom guide members and said first and second side guide members have a linear edge being contiguous with one side of said closed four-sided cutting plane.

12. The torch guide as claimed in claim 11, wherein each of said top and bottom guide members and said first and second side guide members have a torch guiding surface having one dimension extending at a right angle with said longitudinal axis thereof.

13. The torch guide as claimed in claim 10, wherein said top and bottom guiding members are set at an angle of 45° from said longitudinal axis and said first and second side guide members, each having a planar side guiding surface having one dimension aligned at a right angle with said longitudinal axis.

14. The torch guide as claimed in claim 12, wherein said closed four-sided cutting plane is defined by said linear edges.

15. The torch guide as claimed in claim 14, wherein said linear edges are closest to each other relative to said longitudinal axis.

16. The torch guide as claimed in claim 12, wherein said top and bottom guide members are aligned at a 45° angle from said longitudinal axis.

17. The torch guide as claimed in claim 16, wherein said top and bottom guide members have a same width, and said first and second side guide members have a same thickness, and said same thickness is one half of said same width.

18. In combination, a torch guide mounted to a structural metal section;
said structural metal section having a longitudinal axis; said torch guide comprising;
a top and bottom guide members and first and second side guide members;
said first side guide member having a first articulation affixed thereto; said first articulation extending along a first axis of articulation; said first articulation connecting said first side guide member to said top and bottom guide members for adjusting a planar alignment of said first side guide member relative to said top and bottom guide members;
said second side guide member having a second articulation affixed thereto; said second articulation extending along a second axis of articulation; said second articulation connecting said second side guide member to said top and bottom guide members for adjusting a planar alignment of said second side guide member relative to said top and bottom guide members and relative to said first side guide member,
said top guide member being movably affixed to said first and second side guide members about said first and second axes of articulation;
said bottom guide member being movably affixed to said first and second side guide members about said first and second axes of articulation;
said top and bottom guide members and said first and second side guide members defining a closed four-sided cutting plane enclosing said structural section, and
said first and second axes of articulation extending parallel with said closed four-sided cutting plane.

19. The combination as claimed in claim 18, wherein said top and bottom guide members have top and bottom planar guiding surfaces each having a first dimension aligned at a 45° angle from said longitudinal axis and a second dimension aligned at a right angle with said longitudinal axis.

20. The combination as claimed in claim 19, wherein each of said first and second side guide members have a side guiding surface, and each of said side guiding surfaces having a dimension aligned at a right angle with said longitudinal axis.
